(19) United States
(12) Patent Application Publication
(10) Pub. No.: US 2025/0298865 A1
(43) Pub. Date: Sep. 25, 2025

(54) METHOD AND APPARATUS FOR PARALLEL PROCESSING OF MODEL, ELECTRONIC DEVICE AND READABLE STORAGE MEDIUM

(71) Applicant: BEIJING BAIDU NETCOM SCIENCE TECHNOLOGY CO., LTD., Beijing (CN)

(72) Inventors: Guoxia WANG, Beijing (CN); Siming WU, Beijing (CN); Liang SHEN, Beijing (CN); Jinle ZENG, Beijing (CN); Jiabin YANG, Beijing (CN); Dianhai YU, Beijing (CN); Haifeng WANG, Beijing (CN)

(73) Assignee: BEIJING BAIDU NETCOM SCIENCE TECHNOLOGY CO., LTD., Beijing (CN)

(21) Appl. No.: 19/231,265

(22) Filed: Jun. 6, 2025

(30) Foreign Application Priority Data
Dec. 20, 2024 (CN) 202411896113.4

(51) Int. Cl. G06F 17/16

(52) U.S. Cl. CPC G06F 17/16

(57) ABSTRACT

A method for parallel processing of model is suggested, which relates to the field of artificial intelligence technologies such as deep learning, natural language processing, image processing, and large language models. The method is applied to a first computing device among N computing devices, which includes: obtaining a target first data submatrix in N first data submatrices and a target second data submatrix in N second data submatrices; initiating a matrix multiplication operation process to process the target first data submatrix and the target second data submatrix, and in parallel with the processing, copy a first candidate data submatrix in the other N-1 computing devices; in response to obtaining a first processing result between the target first data submatrix and the target second data submatrix, processing the copied first candidate data submatrix and a target data submatrix corresponding to the first candidate data submatrix; in response to obtaining a second processing result between the first candidate data submatrix and the target data submatrix corresponding to the first candidate data submatrix, obtaining a target processing result of the first computing device based on the first processing result and the second processing result.

The present application claims the priority of Chinese Patent Application No. 202411896113.4, filed on Dec. 20, 2024, with the title of “METHOD AND APPARATUS FOR PARALLEL PROCESSING OF MODEL, ELECTRONIC DEVICE AND READABLE STORAGE MEDIUM”. The disclosure of the above application is incorporated herein by reference in its entirety.

### FIELD OF THE DISCLOSURE

The present disclosure relates to the field of computer technology, and in particular to the field of artificial intelligence technologies such as deep learning, natural language processing, image processing, and large language models. The present disclosure provides method and apparatus for parallel processing of model, an electronic device, and a readable storage medium.

### BACKGROUND OF THE DISCLOSURE

With the successful application of deep learning models in various fields, people have begun to focus on how to scale deep learning models to larger sizes to improve their data processing capabilities, accuracy, and performance. Based on this, ultra-large-scale deep learning models have emerged. Ultra-large-scale deep learning models face the pressure in terms of memory and training speed. However, the memory of a single computing device is very limited. Therefore, how to utilize the limited memory of each computing device to train a larger model is a technical problem that urgently needs to be solved.

### SUMMARY OF THE DISCLOSURE

According to the first aspect of the present disclosure, a method for parallel processing of model is provided, which is applied to a first computing device among N computing devices. The method includes: obtaining a target first data submatrix in N first data submatrices and a target second data submatrix in N second data submatrices; wherein the N first data submatrices are obtained by partitioning a first data matrix according to a first partitioning method, and the N second data submatrices are obtained by partitioning a second data matrix according to a second partitioning method; N is a positive integer greater than or equal to 2; initiating a matrix multiplication operation process to process the target first data submatrix and the target second data submatrix, and in parallel with the processing, copy a first candidate data submatrix in the other N-1 computing devices; in response to obtaining a first processing result between the target first data submatrix and the target second data submatrix, processing the copied first candidate data submatrix and a target data submatrix corresponding to the first candidate data submatrix; in response to obtaining a second processing result between the first candidate data submatrix and the target data submatrix corresponding to the first candidate data submatrix, obtaining a target processing result of the first computing device based on the first processing result and the second processing result; wherein the target processing result of the first computing device is used to be concatenated with N-1 target processing results of the other N-1 computing devices to obtain a target processing result between the first data matrix and the second data matrix.

According to the second aspect of the present disclosure, there is provided an electronic device, including: at least one processor; and a memory communicatively connected with the at least one processor; wherein the memory stores instructions executable by the at least one processor, and the instructions are executed by the at least one processor to enable the at least one processor to perform a method for training a question solving model. The method for training a question solving model includes: obtaining a target first data submatrix in N first data submatrices and a target second data submatrix in N second data submatrices; wherein the N first data submatrices are obtained by partitioning a first data matrix according to a first partitioning method, and the N second data submatrices are obtained by partitioning a second data matrix according to a second partitioning method; N is a positive integer greater than or equal to 2; initiating a matrix multiplication operation process to process the target first data submatrix and the target second data submatrix, and in parallel with the processing, copy a first candidate data submatrix in the other N-1 computing devices; in response to obtaining a first processing result between the target first data submatrix and the target second data submatrix, processing the copied first candidate data submatrix and a target data submatrix corresponding to the first candidate data submatrix; in response to obtaining a second processing result between the first candidate data submatrix and the target data submatrix corresponding to the first candidate data submatrix, obtaining a target processing result of the first computing device based on the first processing result and the second processing result; wherein the target processing result of the first computing device is used to be concatenated with N-1 target processing results of the other N-1 computing devices to obtain a target processing result between the first data matrix and the second data matrix.

According to the third aspect of the present disclosure, there is provided a non-transitory computer readable storage medium with computer instructions stored thereon, wherein the computer instructions are used for causing a method for parallel processing of model. The method for training a question solving model includes: obtaining a target first data submatrix in N first data submatrices and a target second data submatrix in N second data submatrices; wherein the N first data submatrices are obtained by partitioning a first data matrix according to a first partitioning method, and the N second data submatrices are obtained by partitioning a second data matrix according to a second partitioning method; N is a positive integer greater than or equal to 2; initiating a matrix multiplication operation process to process the target first data submatrix and the target second data submatrix, and in parallel with the processing, copy a first candidate data submatrix in the other N-1 computing devices; in response to obtaining a first processing result between the target first data submatrix and the target second data submatrix, processing the copied first candidate data submatrix and a target data submatrix corresponding to the first candidate data submatrix; in response to obtaining a second processing result between the first candidate data submatrix and the target data submatrix corresponding to the first candidate data submatrix, obtaining a target processing result of the first computing device based on the first processing result and the second processing result; wherein the target processing result of the first computing device is used to be concatenated with N-1 target processing results of the other N-1 computing devices to obtain a target processing result between the first data matrix and the second data matrix.

It should be understood that the content described in this section is not intended to identify key or important features of the embodiments of the present disclosure, nor is it used to limit the scope of the present disclosure. Other features of the present disclosure will become readily understood through the following specification.

### BRIEF DESCRIPTION OF DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram according to a second embodiment of the present disclosure;

FIG. 3 is a schematic diagram according to a third embodiment of the present disclosure;

FIG. 4 is a schematic diagram according to a fourth embodiment of the present disclosure;

FIG. 5 is a schematic diagram according to a fifth embodiment of the present disclosure;

FIG. 6 is a schematic diagram according to a sixth embodiment of the present disclosure;

FIG. 7 is a schematic diagram according to a seventh embodiment of the present disclosure;

FIG. 8 is a schematic diagram according to an eighth embodiment of the present disclosure;

FIG. 9 is a schematic diagram according to a ninth embodiment of the present disclosure;

FIG. 10 is a schematic diagram according to a tenth embodiment of the present disclosure;

FIG. 11 is a schematic diagram according to an eleventh embodiment of the present disclosure;

FIG. 12 is a schematic diagram according to a twelfth embodiment of the present disclosure;

FIG. 13 is a schematic diagram according to a thirteenth embodiment of the present disclosure;

FIG. 14 is a schematic diagram according to a fourteenth embodiment of the present disclosure;

FIG. 15 is a schematic diagram according to a fifteenth embodiment of the present disclosure;

FIG. 16 is a schematic diagram according to a sixteenth embodiment of the present disclosure;

FIG. 17 is a schematic diagram according to a seventeenth embodiment of the present disclosure;

FIG. 18 is a schematic diagram according to an eighteenth embodiment of the present disclosure;

FIG. 19 is a schematic diagram according to a nineteenth embodiment of the present disclosure;

FIG. 20 is a schematic diagram according to a twentieth embodiment of the present disclosure;

FIG. 21 is a schematic diagram according to a twenty-first embodiment of the present disclosure;

FIG. 22 is a schematic diagram according to a twenty-second embodiment of the present disclosure;

FIG. 23 is a schematic diagram according to a twenty-third embodiment of the present disclosure;

FIG. 24 is a schematic diagram according to a twenty-fourth embodiment of the present disclosure;

FIG. 25 is a schematic diagram according to a twenty-fifth embodiment of the present disclosure;

FIG. 26 is a schematic diagram according to a twenty-sixth embodiment of the present disclosure;

FIG. 27 is a schematic diagram according to a twenty-seventh embodiment of the present disclosure; and

FIG. 28 is a block diagram of an electronic device configured to implement the method for parallel processing of model according to embodiments of the present disclosure.

### DETAILED DESCRIPTION OF PREFERRED EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and mechanisms are omitted in the descriptions below.

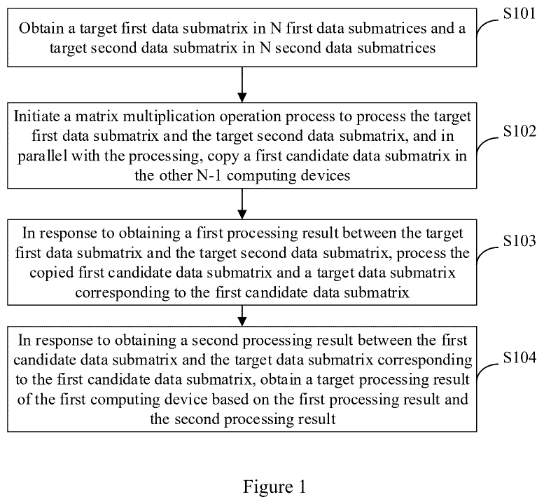

FIG. 1 is a schematic diagram according to a first embodiment of the present disclosure. As shown in FIG. 1, a method for parallel processing of model according to the present embodiment is applied to a first computing device among N computing devices, and specifically includes the following steps:
S101: Obtaining a target first data submatrix in N first data submatrices and a target second data submatrix in N second data submatrices; wherein the N first data submatrices are obtained by partitioning a first data matrix according to a first partitioning method, and the N second data submatrices are obtained by partitioning a second data matrix according to a second partitioning method; N is a positive integer greater than or equal to 2;
S102: Initiating a matrix multiplication operation process to process the target first data submatrix and the target second data submatrix, and in parallel with the processing, copy a first candidate data submatrix in the other N-1 computing devices;
S103: In response to obtaining a first processing result between the target first data submatrix and the target second data submatrix, processing the copied first candidate data submatrix and a target data submatrix corresponding to the first candidate data submatrix;
S104: In response to obtaining a second processing result between the first candidate data submatrix and the target data submatrix corresponding to the first candidate data submatrix, obtaining a target processing result of the first computing device based on the first processing result and the second processing result; wherein the target processing result of the first computing device is used to be concatenated with N-1 target processing results of the other N-1 computing devices to obtain a target processing result between the first data matrix and the second data matrix.

In the present embodiment, the first data matrix can be a feature matrix corresponding to an input data or a weight matrix corresponding to a target model; the second data matrix can be a feature matrix corresponding to an input data or a weight matrix corresponding to a target model.

In the present embodiment, the target model is a deep learning model, and the elements in the weight matrix corresponding to the target model are the parameters in the deep learning model. It can be understood that the weight matrix in the present embodiment can be the weight matrix of some network layers in the target model. In the present embodiment, if the target model is an image processing model and the input data is an image, then the feature matrix corresponding to the input data can be a matrix composed of pixel values of each pixel in the image. If the target model is a natural language processing model and the input data is text, then the feature matrix corresponding to the input data can be a matrix composed of word vectors of each word in the text.

In the present embodiment, the computing device can be a device having parallel computing capabilities, such as a GPU (Graphics Processing Unit), an NPU (Neural Processing Unit), a GPU-like device, or an XPU, which is not limited in the present embodiment.

In the present embodiment, the first computing device is one of the N computing devices, where the N computing devices correspond respectively to the N first data submatrices and the N second data submatrices one by one, and N is a positive integer greater than or equal to 2. The data submatrices corresponding to different computing devices can be stored in the memory of the respective computing devices.

In the present embodiment, any partitioning method can be used to partition the first data matrix and the second data matrix. The first partitioning method corresponding to the first data matrix and the second partitioning method corresponding to the second data matrix can be either the same or different.

In other words, the present embodiment does not limit the partitioning method of the data submatrices obtained by the computing devices, so that the computing devices can perform parallel processing on the data submatrices obtained by any partitioning method, thereby expanding the usage scenarios and achieving the purpose of truly distributed parallel matrix multiplication by the computing devices such as a GPU, an NPU, a GPU-like device, or an XPU.

In the present embodiment, the first partitioning method can be row partitioning (i.e. partitioning the first data matrix in the row direction) or column partitioning (i.e. partitioning the first data matrix in the column direction). The second partitioning method can be row partitioning (i.e. partitioning the second data matrix in the row direction) or column partitioning (i.e. partitioning the second data matrix in the column direction).

Here, a row partitioning refers to partitioning a data matrix with M rows and K columns into N data submatrices with M/N rows and K columns; a column partitioning refers to partitioning a data matrix with M rows and K columns into N data sub-matrices with M rows and K/N columns.

In the present embodiment, each first data submatrix among the N first data submatrices and each second data submatrix among the N second data submatrices are distributed to different computing devices. Then when the first computing device executes S101, the first computing device uses the distributed first data submatrix as the target first data submatrix and the distributed second data submatrix as the target second data submatrix.

In the present embodiment, after the first computing device executes S101 to receive the target first data submatrix and the target second data submatrix, the first computing device executes S102 to initiate the matrix multiplication operation process to process the received target first data submatrix and the target second data submatrix, and in parallel with the processing, copy the first candidate data submatrix in the other N-1 computing devices.

In the present embodiment, when the first computing device executes S102, the first computing device can initiate the matrix multiplication operation process by calling a General Matrix Multiply (GEMM) kernel.

In the present embodiment, after the first computing device executes S102 to complete the initiation of the matrix multiplication operation process, the first computing device can copy the first candidate data submatrix in the other N-1 computing devices in parallel with the matrix multiplication operation processing on the target first data submatrix and target second data submatrix.

In other words, the first computing device in the present embodiment communicates with the other N-1 computing devices in parallel with the processing of the matrix multiplication operation on the existing data submatrices, thereby copying the first candidate data submatrix in the other N-1 computing devices, which can achieve an overlap between computing and communication during the parallel processing by the computing devices such as a GPU, an NPU, a GPU-like device, or an XPU.

In the present embodiment, when the first computing device executes S102 to process the received target first data submatrix and the target second data submatrix, the implementation method that can be applied is: dividing the target first data submatrix into a plurality of target first matrix blocks and dividing the target second data submatrix into a plurality of target second matrix blocks according to a first preset block size; obtaining a processing result between the target first data submatrix and the target second data submatrix based on the plurality of target first matrix blocks and the plurality of target second matrix blocks, and the obtained processing result is the result of the matrix multiplication.

In the present embodiment, the first preset block size can be a block size that matches the size of a Warp (a Warp is a basic unit for scheduling and execution in a GPU).

In other words, the present embodiment achieves the purpose of performing Warp-level computing within the called GEMM kernel by dividing the data submatrices and then performing matrix multiplication operation between the data submatrices according to the matrix blocks obtained by the dividing, which can improve the computing efficiency of the first computing device such as a GPU, an NPU, a GPU-like device, or an XPU when performing matrix multiplication.

In the present embodiment, the first candidate data submatrix to be copied by the first computing device from the other N-1 computing devices can be all or some of the first data submatrices corresponding to the other N-1 computing devices, or can be all or some of the second data submatrices corresponding to the other N-1 computing devices.

In the present embodiment, when the first computing device executes S102 to copy the first candidate data submatrix in the other N-1 computing devices, the implementation method that can be applied is: constructing a partitioning method set based on the first partitioning method, the second partitioning method, and a third partitioning method corresponding to the output data matrix; determining the first candidate data submatrix based on the constructed partitioning method set; copying the first candidate data submatrix in the other N-1 computing devices.

The first computing device in the present embodiment achieves the purpose of copying the first candidate data submatrix from the other N-1 computing devices by accessing the memory of the other N-1 computing devices.

In the present embodiment, the output data matrix is the target processing result between the first data matrix and the second data matrix. The third partitioning method can be row partitioning (i.e. partitioning the output data matrix in the row direction) or column partitioning (i.e. partitioning the output data matrix in the column direction).

Since the present embodiment supports arbitrary partitioning of the input data matrix and the output data matrix (usually the matrix is partitioned evenly), the partitioning method set constructed according to the matrix partitioning methods of the present embodiment has 8 scenarios, specifically: (row partitioning, row partitioning, row partitioning), (row partitioning, row partitioning, column partitioning), (row partitioning, column partitioning, row partitioning), (row partitioning, column partitioning, column partitioning), (column partitioning, row partitioning, row partitioning), (column partitioning, row partitioning, column partitioning), (column partitioning, column partitioning, row partitioning), and (column partitioning, column partitioning, column partitioning). In the present embodiment, different partitioning method sets correspond to different types of the first candidate data submatrix. Thus, the first computing device determines what type of the first candidate data submatrix to copy from the other N-1 computing devices based on the constructed partitioning method set.

In the present embodiment, the first computing device obtains the first candidate data submatrix required for matrix multiplication operation from the other N-1 computing devices by copying, thereby avoiding the steps of sending and receiving submatrices between computing devices. This can reduce the time required for the computing device, such as a GPU, an NPU, a GPU-like device, or an XPU, to obtain the first candidate data submatrix in the other N-1 computing devices, thereby improving the efficiency of subsequent matrix multiplication operation based on the first candidate data submatrix.

The first computing device in the present embodiment can store the copied first candidate data submatrix corresponding to different other computing devices into the memory of the first computing device, so as to obtain the first candidate data submatrix during subsequent processing.

The first computing device in the present embodiment, when executing S102 to copy first candidate data submatrix from the other N-1 computing devices, can copy the first candidate data submatrix in the other N-1 computing devices multiple times according to a second preset block size, that is, copy matrix blocks corresponding to the second preset block size from the other N-1 computing devices each time. The second preset block size in the present embodiment can be the same as or different from the first preset block size. The second preset block size in the present embodiment can be set according to actual requirements.

In other words, the first computing device in the present embodiment can copy the first candidate data submatrix in the other N-1 computing devices multiple times according to smaller blocks. Thus, after completing the processing between the target first data submatrix and the target second data submatrix, the first computing device can perform matrix multiplication operation more quickly using the already copied first candidate data submatrix (or the matrix blocks corresponding to the first candidate data submatrix), which can further improve the overlap efficiency between computing and communication for the computing device, such as a GPU, an NPU, a GPU-like device, or an XPU.

After executing S102, the first computing device in the present embodiment executes S103 to process the copied first candidate data submatrix and the target data submatrix corresponding to the first candidate data submatrix, in response to obtaining the first processing result between the target first data submatrix and the target second data submatrix.

In the present embodiment, if the first candidate data submatrix is the first data submatrix in the other N-1 computing devices, then the target data submatrix corresponding to the first candidate data submatrix is the target second data submatrix in the first computing device. If the first candidate data submatrix is the second data submatrix in the other N-1 computing devices, then the target data submatrix corresponding to the first candidate data submatrix is the target first data submatrix in the first computing device.

After the first computing device executes S103 to determine that the matrix multiplication operation between the target first data submatrix and target second data submatrix is completed, it can immediately perform matrix multiplication operation between the first candidate data submatrix which is copied from the other N-1 computing devices and the target data submatrix corresponding to the first candidate data submatrix.

It can be understood that the executing of S103 by the first computing device may also include: obtaining a status of copying the first candidate data submatrix; in response to determining that the status is that the copying is not completed, continuing to copy the remaining first candidate data submatrix in the other N-1 computing devices, in parallel with processing the copied first candidate data submatrix and the target data submatrix corresponding to the first candidate data submatrix.

After executing S103, the first computing device executes S104 to obtain the target processing result of the first computing device based on the first processing result and the candidate processing result, in response to obtaining the second processing result between the first candidate data submatrix and the target data submatrix corresponding to the first candidate data submatrix.

In the present embodiment, the target processing result of the first computing device is concatenated with the N-1 target processing results of the other N-1 computing devices to obtain the output data matrix, which is the target processing result between the first data matrix and the second data matrix.

In the present embodiment, the first computing device executes S104 to obtain the second processing result, which is the complete processing result between the first candidate data submatrix and the target data submatrix corresponding to the first candidate data submatrix.

After the first computing device executes S104 to obtain the second processing result between the first candidate data submatrix and the target data submatrix corresponding to the first candidate data submatrix, it can close the matrix multiplication operation process, and then obtain the target processing result corresponding to the first computing device based on the first processing result and the second processing result.

In some special cases, such as when the first candidate data submatrix copied by the first computing device is the first data submatrix in the other N-1 computing devices, when executing S104, the first computing device obtains the target processing result corresponding to the first computing device based on the first computing result and the second computing result copied from the other N-1 computing devices.

In other words, the first computing device in the present embodiment can obtain the target processing result either based on the first computing result and second computing result computed by itself, or based on the first computing result computed by itself and the second computing result computed by other computing devices, which can further improve the accuracy of the obtained target processing result. With the method for parallel processing of model of the present embodiment, the GEMM kernel only needs to be called once as a whole, thereby avoiding the issue of multiple GEMM kernel calls by the first computing device, such as a GPU, an NPU, a GPU-like device, or an XPU. This improves the computing efficiency of the first computing device, such as a GPU, an NPU, a GPU-like or an XPU, when performing matrix multiplication. Moreover, when the required data submatrices for matrix multiplication operation are ready, the first computing device, such as a GPU, an NPU, a GPU-like device, or an XPU, can perform matrix multiplication operation, without affecting the data submatrix copying process. This means that when performing parallel processing of model, the computing and communication of the first computing device, such as a GPU, an NPU, a GPU-like or an XPU, overlap with each other without affecting the computing efficiency of matrix multiplication. This can greatly improve the efficiency of the overlapping computing and communication of the first computing device. such as a GPU, an NPU, a GPU-like or an XPU, thereby more efficiently achieving the purpose of performing distributed parallel matrix computing by the first computing device, such as a GPU, an NPU, a GPU-like or an XPU.

In the present embodiment, the weight matrix can include the parameters of some network layers of the target model. Correspondingly, the processing result between the feature matrix and weight matrix can be the processing result of some network layers in the target model, i.e., an intermediate processing result.

Therefore, in practical applications, when the target processing results of various computing devices are obtained, it can be determined whether to concatenate the target processing results of each computing device according to the structure of the model. For example, it can be chosen to either maintain the partitioned state to process the next network layer, or it can be chosen to concatenate the processing results of each computing device to obtain the target processing result between the feature matrix and the weight matrix.

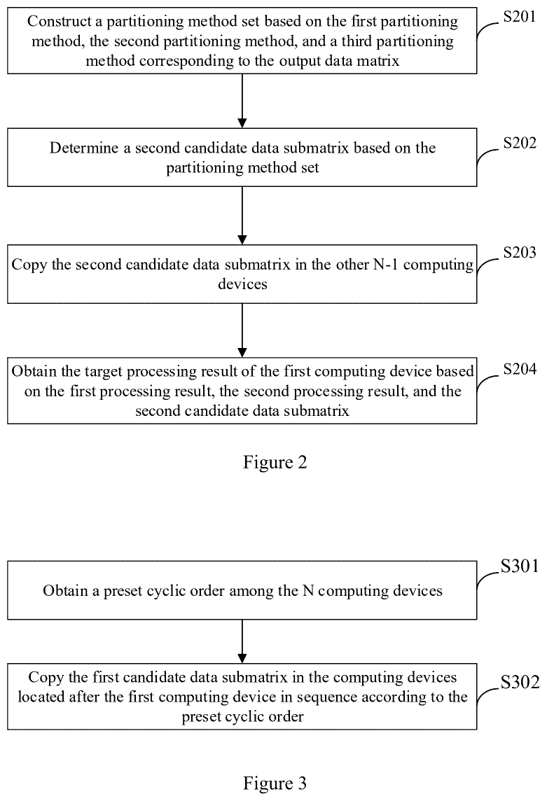

FIG. 2 is a schematic diagram according to a second embodiment of the present disclosure. As shown in FIG. 2, when executing S104 of “obtaining a target processing result of the first computing device based on the first processing result and the second processing result”, the implementation method that can be applied in the present embodiment can include:
S201: Constructing a partitioning method set based on the first partitioning method, the second partitioning method, and a third partitioning method corresponding to the output data matrix;
S202: Determining a second candidate data submatrix based on the partitioning method set;
S203: Copying the second candidate data submatrix in the other N-1 computing devices;
S204: Obtaining the target processing result of the first computing device based on the first processing result, the second processing result, and the second candidate data submatrix.

In other words, the first computing device in the present embodiment can also determine the second candidate data submatrices to be copied from the other N-1 computing devices based on the constructed partitioning method set, and then obtain the corresponding target processing result based on the first processing result and the second processing result which are obtained by its own, and the copied second candidate data submatrices.

In the present embodiment, different partitioning method sets correspond to different second candidate data submatrices. The second candidate data submatrices are the second computing results obtained through matrix multiplication operation by the other N-1 computing devices.

FIG. 3 is a schematic diagram according to a third embodiment of the present disclosure. As shown in FIG. 3, when executing S102 of “copy first candidate data submatrices in the other N-1 computing devices”, the implementation method that can be applied in the present embodiment can include:
S301: Obtaining a preset cyclic order among the N computing devices;
S302: Copying the first candidate data submatrix in the computing devices located after the first computing device in sequence according to the preset cyclic order.

In other words, the first computing device in the present embodiment copies the first candidate data submatrix in the computing devices located after it in sequence according to the preset cyclic order among N computing devices, ensuring orderly progress of the data copying process in the first computing device, such as a GPU, an NPU, a GPU-like device, or an XPU.

In the present embodiment, the preset cyclic order refers to the order in which a circle is formed between the devices. For example, if the N computing devices include a computing device 0, a computing device 1, a computing device 2, and a computing device 3, then the preset cyclic order is the order of a circle formed by the computing device 0—the computing device 1—the computing device 2—the computing device 3—the computing device 0.

In the present embodiment, when executing S302, the first computing device copies the first candidate data submatrix from the computing devices located after it in sequence, so that after completing the copy of the candidate data submatrix from the current computing device, the candidate data submatrix in the computing device next to the current computing device is copied, and the process continues.

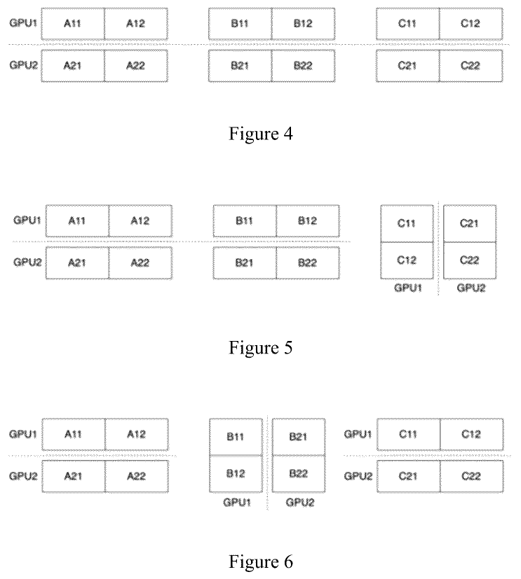

FIG. 4 is a schematic diagram according to the fourth embodiment of the present disclosure. FIG. 4 shows a schematic diagram of the first method of defined matrix partitioning for the first data matrix, the second data matrix, and the output data matrix, wherein the first partitioning method is row partitioning, the second partitioning method is row partitioning, and the third partitioning method is row partitioning.

FIG. 5 is a schematic diagram according to the fifth embodiment according to the present disclosure. FIG. 5 shows a schematic diagram of the second method of defined matrix partitioning for the first data matrix, the second data matrix, and the output data matrix, wherein the first partitioning method is row partitioning, the second partitioning method is row partitioning, and the third partitioning method is column partitioning.

FIG. 6 is a schematic diagram according to the sixth embodiment according to the present disclosure. FIG. 6 shows a schematic diagram of the third method of defined matrix partitioning for the first data matrix, the second data matrix, and the output data matrix, wherein the first partitioning method is row partitioning, the second partitioning method is column partitioning, and the third partitioning method is row partitioning.

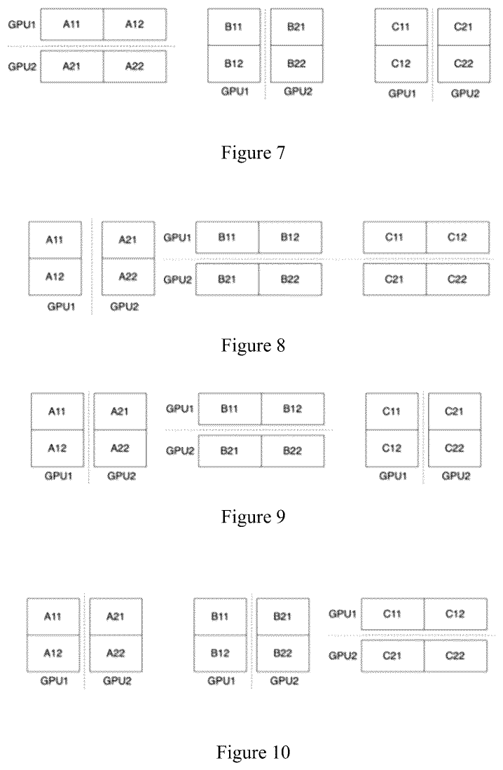

FIG. 7 is a schematic diagram according to the seventh embodiment according to the present disclosure. FIG. 7 shows a schematic diagram of the fourth method of defined matrix partitioning for the first data matrix, the second data matrix, and the output data matrix, wherein the first partitioning method is row partitioning, the second partitioning method is column partitioning, and the third partitioning method is column partitioning.

FIG. 8 is a schematic diagram according to the eighth embodiment according to the present disclosure. FIG. 8 shows a schematic diagram of the fifth method of defined matrix partitioning for the first data matrix, the second data matrix, and the output data matrix, wherein the first partitioning method is column partitioning, the second partitioning method is row partitioning, and the third partitioning method is row partitioning.

FIG. 9 is a schematic diagram according to the ninth embodiment according to the present disclosure. FIG. 9 shows a schematic diagram of the sixth method of defined matrix partitioning for the first data matrix, the second data matrix, and the output data matrix, wherein the first partitioning method is column partitioning, the second partitioning method is row partitioning, and the third partitioning method is column partitioning.

FIG. 10 is a schematic diagram according to the tenth embodiment according to the present disclosure. FIG. 10 shows a schematic diagram of the seventh method of defined matrix partitioning for the first data matrix, the second data matrix, and the output data matrix, wherein the first partitioning method is column partitioning, the second partitioning method is column partitioning, and the third partitioning method is row partitioning.

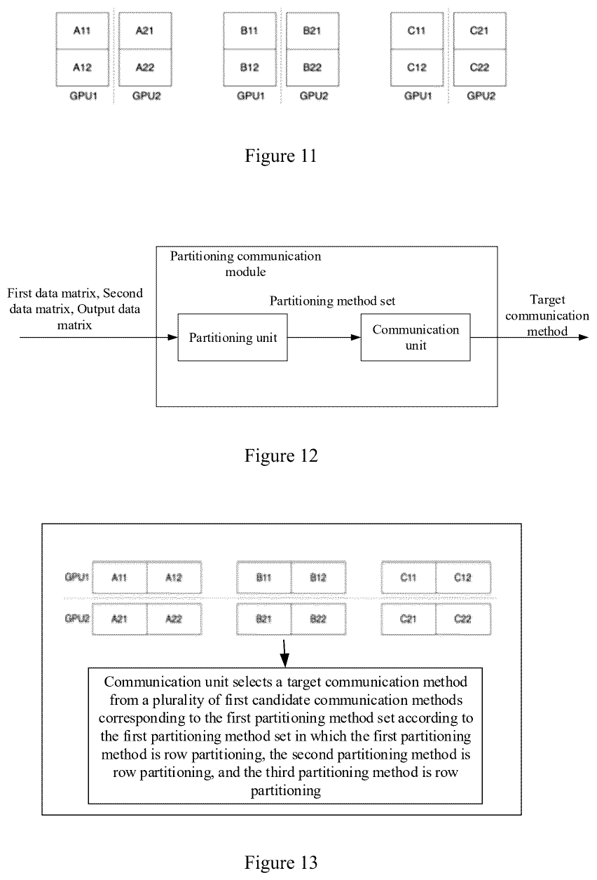

FIG. 11 is a schematic diagram according to the eleventh embodiment according to the present disclosure. FIG. 11 shows a schematic diagram of the eighth method of defined matrix partitioning for the first data matrix, the second data matrix, and the output data matrix, wherein the first partitioning method is column partitioning, the second partitioning method is column partitioning, and the third partitioning method is column partitioning.

FIG. 12 is a schematic diagram according to the twelfth embodiment of the present disclosure. FIG. 12 shows a schematic diagram of the partitioning communication module of the present embodiment. In the present embodiment, a partitioning unit in the partitioning communication module is used to partition the first data matrix, the second data matrix, and the output data matrix using any defined partitioning method (such as any partitioning method in the fourth to eleventh embodiments). The communication unit in the partitioning communication module is used to select a target communication method from the candidate communication methods in the corresponding partitioning method set according to the partitioning method used by the partitioning unit.

FIG. 13 is a schematic diagram according to the thirteenth embodiment of the present disclosure. FIG. 13 shows a schematic diagram of selecting a target communication method when using the first method of defined matrix partitioning: the communication unit selects a target communication method from a plurality of first candidate communication methods corresponding to the first partitioning method set according to the first partitioning method set in which the first partitioning method is row partitioning, the second partitioning method is row partitioning, and the third partitioning method is row partitioning.

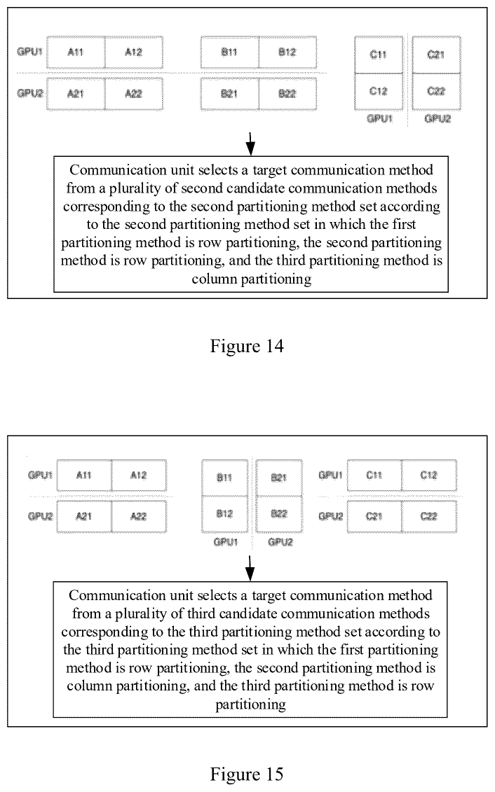

FIG. 14 is a schematic diagram according to the fourteenth embodiment of the present disclosure. FIG. 14 shows a schematic diagram of selecting a target communication method when using the second method of defined matrix partitioning: the communication unit selects a target communication method from a plurality of second candidate communication methods corresponding to the second partitioning method set according to the second partitioning method set in which the first partitioning method is row partitioning, the second partitioning method is row partitioning, and the third partitioning method is column partitioning.

FIG. 15 is a schematic diagram according to the fifteenth embodiment of the present disclosure. FIG. 15 shows a schematic diagram of selecting a target communication method when using the third method of defined matrix partitioning: the communication unit selects a target communication method from a plurality of third candidate communication methods corresponding to the third partitioning method set according to the third partitioning method set in which the first partitioning method is row partitioning, the second partitioning method is column partitioning, and the third partitioning method is row partitioning.

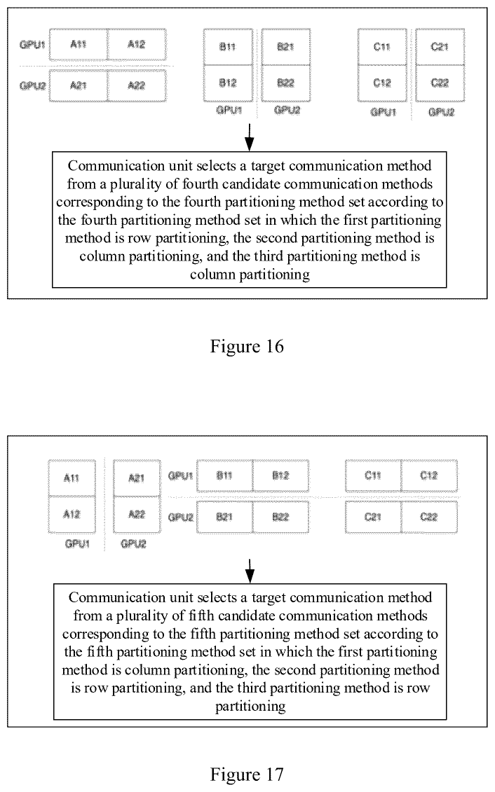

FIG. 16 is a schematic diagram according to the sixteenth embodiment of the present disclosure. FIG. 16 shows a schematic diagram of selecting a target communication method when using the fourth method of defined matrix partitioning: the communication unit selects a target communication method from a plurality of fourth candidate communication methods corresponding to the fourth partitioning method set according to the fourth partitioning method set in which the first partitioning method is row partitioning, the second partitioning method is column partitioning, and the third partitioning method is column partitioning.

FIG. 17 is a schematic diagram according to the seventeenth embodiment of the present disclosure. FIG. 17 shows a schematic diagram of selecting a target communication method when using the fifth method of defined matrix partitioning: the communication unit selects a target communication method from a plurality of fifth candidate communication methods corresponding to the fifth partitioning method set according to the fifth partitioning method set in which the first partitioning method is column partitioning, the second partitioning method is row partitioning, and the third partitioning method is row partitioning.

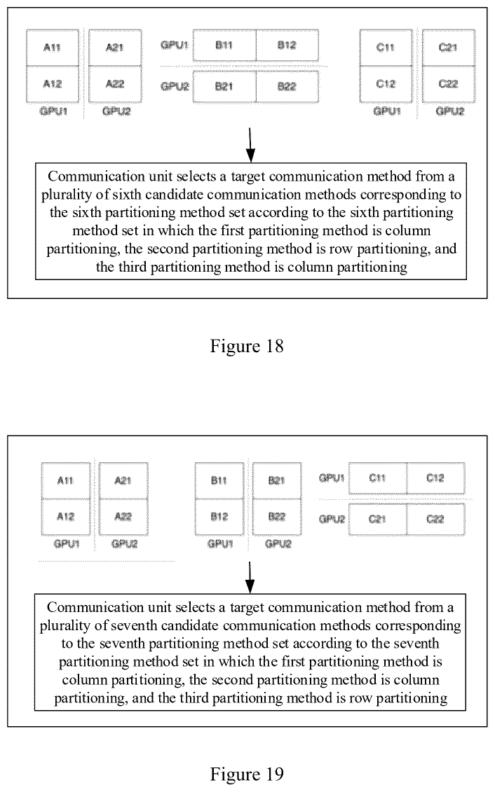

FIG. 18 is a schematic diagram according to the eighteenth embodiment of the present disclosure. FIG. 18 shows a schematic diagram of selecting a target communication method when using the sixth method of defined matrix partitioning: the communication unit selects a target communication method from a plurality of sixth candidate communication methods corresponding to the sixth partitioning method set according to the sixth partitioning method set in which the first partitioning method is column partitioning, the second partitioning method is row partitioning, and the third partitioning method is column partitioning.

FIG. 19 is a schematic diagram according to the nineteenth embodiment of the present disclosure. FIG. 19 shows a schematic diagram of selecting a target communication method when using the seventh method of defined matrix partitioning: the communication unit selects a target communication method from a plurality of seventh candidate communication methods corresponding to the seventh partitioning method set according to the seventh partitioning method set in which the first partitioning method is column partitioning, the second partitioning method is column partitioning, and the third partitioning method is row partitioning.

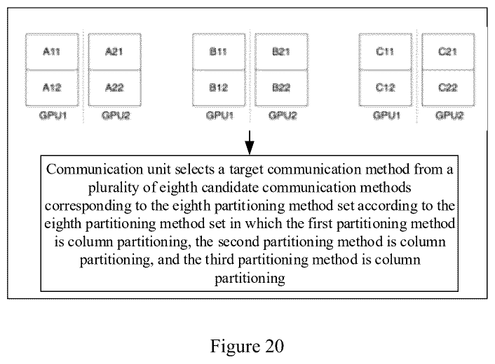

FIG. 20 is a schematic diagram according to the twentieth embodiment of the present disclosure. FIG. 20 shows a schematic diagram of selecting a target communication method when using the eighth method of defined matrix partitioning: the communication unit selects a target communication method from a plurality of eighth candidate communication methods corresponding to the eighth partitioning method set according to the eighth partitioning method set in which the first partitioning method is column partitioning, the second partitioning method is column partitioning, and the third partitioning method is column partitioning.

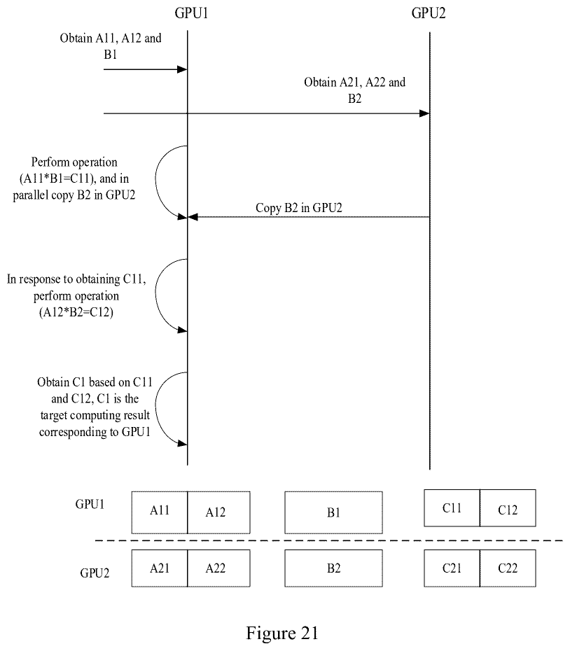

FIG. 21 is a schematic diagram according to the twenty-first embodiment of the present disclosure. FIG. 21 shows a processing flow diagram of the first computing device performing parallel processing of model based on a target communication method selected in the thirteenth embodiment. In the present embodiment, the first partitioning method is row partitioning, the second partitioning method is row partitioning, and the third partitioning method is row partitioning.

As shown in FIG. 21, the present embodiment includes two computing devices, namely GPU1 and GPU2, where GPU is the first computing device and GPU2 is the other computing device corresponding to GPU1. The target first data submatrix obtained by GPU1 is A1 composed of A11 and A12, and the target second data submatrix is B1. The target first data submatrix obtained by GPU2 is A2 composed of A21 and A22, and the target second data submatrix is B2.

In the present embodiment, GPU1 performs matrix multiplication operation based on the obtained A11 and B1, and in parallel with this processing, copies B2 (i.e. the first candidate data submatrix) in GPU2. After GPU1 determines that the matrix multiplication operation between A11 and B1 to obtain (A11*B1=C11) is completed, GPU1 continues to perform matrix multiplication operation based on A12 and the copied B2 to obtain (A12*B2=C22). GPU1 then obtains (C11+C12=C1) based on the obtained C11 (i.e. the first computing result) and C12 (i.e. the second computing result), where C1 is the target computing result of the first computing device.

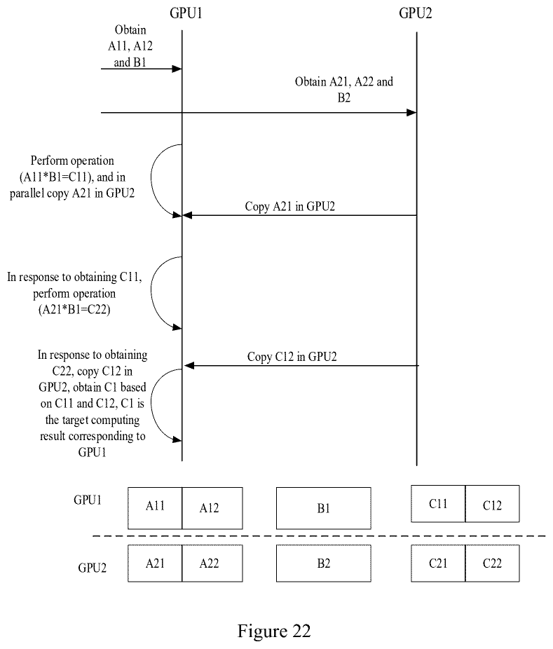

FIG. 22 is a schematic diagram according to the twenty-second embodiment of the present disclosure. FIG. 22 shows a processing flow diagram of the first computing device performing parallel processing of model based on another target communication method selected in the thirteenth embodiment. In the present embodiment, the first partitioning method is row partitioning, the second partitioning method is row partitioning, and the third partitioning method is row partitioning.

As shown in FIG. 22, the present embodiment includes two computing devices, namely GPU1 and GPU2, where GPU1 is the first computing device and GPU2 is the other computing device corresponding to GPU1. The target first data submatrix obtained by GPU1 is A1 composed of A11 and A12, and the target second data submatrix is B1. The target first data submatrix obtained by GPU2 is A2 composed of A21 and A22, and the target second data submatrix is B2.

In the present embodiment, GPU1 performs matrix multiplication operation based on the obtained A11 and B1, and in parallel with this processing, copies A21 (i.e. the first candidate data submatrix) in GPU2. After GPU1 determines that the matrix multiplication operation between A11 and B1 is completed and (A11*B1=C11) is obtained, GPU1 continues to perform matrix multiplication operation to obtain (A21*B1=C22). After GPU1 determines that the operation of C22 is completed, it copies C12 in GPU2; GPU1 obtains (C11+C12=C1) based on C11 (i.e., the first computing result) and C12, where C1 is the target computing result of the first computing device.

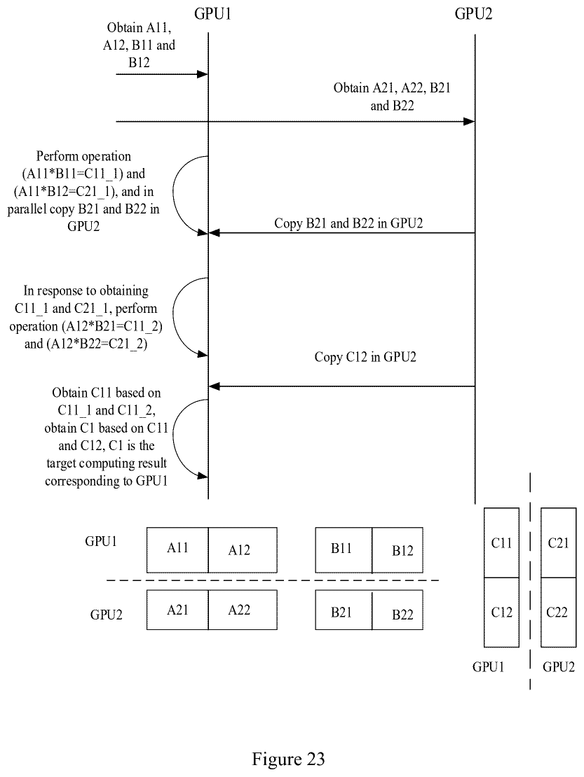

FIG. 23 is a schematic diagram according to the twenty-third embodiment of the present disclosure. FIG. 23 shows a processing flow diagram of the first computing device performing parallel processing of model based on a target communication method selected in the fourteenth embodiment. In the present embodiment, the first partitioning method is row partitioning, the second partitioning method is row partitioning, and the third partitioning method is column partitioning.

As shown in FIG. 23, the present embodiment includes two computing devices, namely GPU1 and GPU2, where GPU1 is the first computing device and GPU2 is the other computing device corresponding to GPU1. The target first data submatrix obtained by GPU1 is A1 composed of A11 and A12, and the target second data submatrix is B1 composed of B11 and B12. The target first data submatrix obtained by GPU2 is A2 composed of A21 and A22, and the target second data submatrix is B2 composed of B21 and B22.

In the present embodiment, GPU1 performs matrix multiplication operation based on the obtained A11 and B11, as well as A11 and B12, and in parallel with this process, copies B21 and B22 (i.e. the first candidate data submatrix) in GPU2. After GPU1 determines that the matrix multiplication operation between A11 and B11 to obtain (A11*B11=C11_1), as well as the matrix multiplication operation between A11 and B12 to obtain (A11*B12=C21_1), are completed, GPU1 continues to perform matrix multiplication operation based on A12 and the copied B21, as well as A12 and the copied B22, to respectively obtain (A12*B21=C11_2) and (A12*B22=C21_2). GPU1 then obtains (C11+C12=C1) based on C11 which is obtained based on C11_1 (i.e. the first computing result) and C11_2 (i.e. the second computing result), and based on C12 (i.e. the second candidate data submatrix) which is copied from GPU2, where C1 is the target computing result of the first computing device.

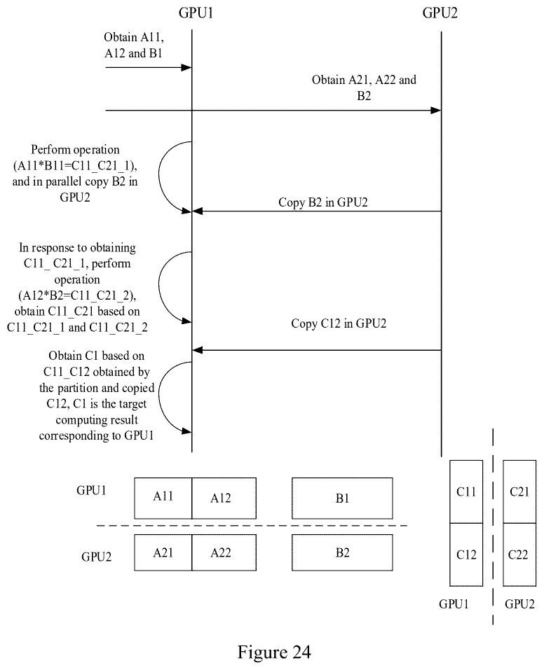

FIG. 24 is a schematic diagram according to the twenty-fourth embodiment of the present disclosure. FIG. 24 shows a processing flow diagram of the first computing device performing parallel processing of model based on another target communication method selected in the fourteenth embodiment. In the present embodiment, the first partitioning method is row partitioning, the second partitioning method is row partitioning, and the third partitioning method is column partitioning.

As shown in FIG. 24, the present embodiment includes two computing devices, namely GPU1 and GPU2, where GPU1 is the first computing device and GPU2 is the other computing device corresponding to GPU1. The target first data submatrix obtained by GPU1 is A1 composed of A11 and A12, and the target second data submatrix is B1. The target first data submatrix obtained by GPU2 is A2 composed of A21 and A22, and the target second data submatrix is B2.

In the present embodiment, GPU1 performs matrix multiplication operation based on the obtained A11 and B11, and in parallel with this processing, copies B2 (i.e. the first candidate data submatrix) in GPU2. After GPU1 determines that the matrix multiplication operation between A11 and B11 to obtain (A11*B11=C11_C21_1) is completed, GPU1 continues to perform matrix multiplication operation based on the copied B2 and A12 to obtain (A12*B2=C11_C21_2), and then it obtains C11_C21 based on C11_C21_2 and C11_C21_1. After GPU1 partitions C11_C21 into C11 and C21, GPU1 then obtains (C11+C12=C1) based on C12 which is copied from GPU2 and C11 which is obtained by the partition, where C1 is the target computing result of the first computing device.

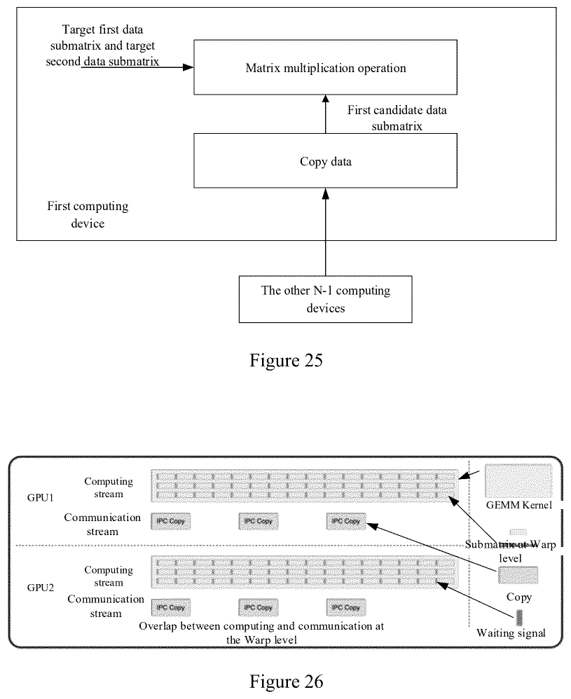

FIG. 25 is a schematic diagram according to the twenty-fifth embodiment of the present disclosure. FIG. 25 shows a framework diagram of parallel processing by the first computing device in the twenty-fifth embodiment: the first computing device in FIG. 25 performs matrix multiplication operations, and in parallel with the processing, performs operations on the first candidate data submatrix in the other N-1 computing devices, which can achieve an overlap between computing and communication. The first computing device also continues matrix multiplication operations using the copied first candidate data submatrix, thereby improving the computing efficiency of the matrix multiplication.

FIG. 26 is a schematic diagram according to the twenty-sixth embodiment of the present disclosure. The present embodiment shows the overlap between computing and communication at the Warp level. In the present embodiment, GPU1 and GPU2 further partition the submatrices for matrix multiplication into matrix blocks corresponding to the Warp-level, and then perform matrix multiplication operations based on the matrix blocks. In addition, during the processing of the above operation, IPC Copy is also performed to copy the corresponding data in the other computing devices for subsequent matrix multiplication operations.

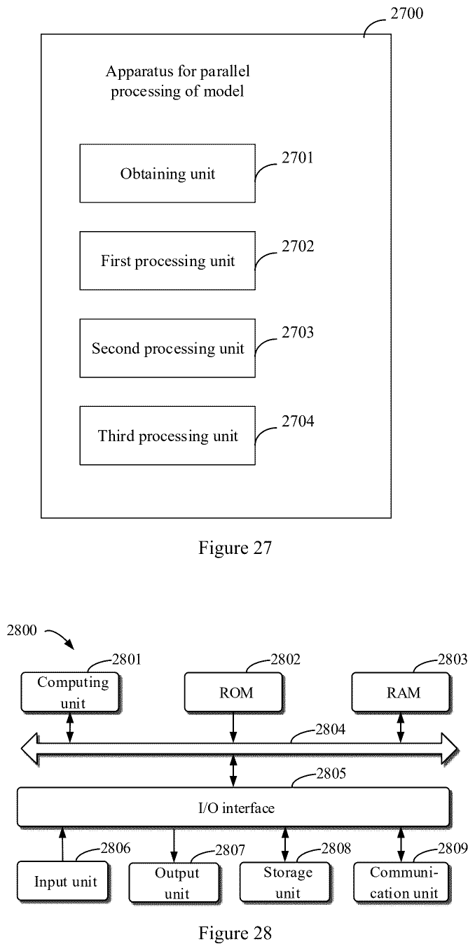

FIG. 27 is a schematic diagram according to the twenty-seventh embodiment of the present disclosure. As shown in FIG. 27, an apparatus 2700 for parallel processing of model according to the present embodiment which is located in a first computing device among N computing devices, includes:
Obtaining unit 2701, configured to obtain a target first data submatrix in N first data submatrices and a target second data submatrix in N second data submatrices; wherein the N first data submatrices are obtained by partitioning a first data matrix according to a first partitioning method, and the N second data submatrices are obtained by partitioning a second data matrix according to a second partitioning method; N is a positive integer greater than or equal to 2;
First processing unit 2702, configured to initiate a matrix multiplication operation process to process the target first data submatrix and the target second data submatrix, and in parallel with the processing, copy a first candidate data submatrix in the other N-1 computing devices;
Second processing unit 2703, configured to in response to obtaining a first processing result between the target first data submatrix and the target second data submatrix, process the copied first candidate data submatrix and a target data submatrix corresponding to the first candidate data submatrix;
Third processing unit 2704, configured to in response to obtaining a second processing result between the first candidate data submatrix and the target data submatrix corresponding to the first candidate data submatrix, obtain a target processing result of the first computing device based on the first processing result and the second processing result; wherein the target processing result of the first computing device is used to be concatenated with N-1 target processing results of the other N-1 computing devices to obtain a target processing result between the first data matrix and the second data matrix.

In the present embodiment, each first data submatrix among the N first data submatrices and each second data submatrix among the N second data submatrices are distributed to different computing devices. The obtaining unit 2701 uses the distributed first data submatrix as the target first data submatrix and the distributed second data submatrix as the target second data submatrix.

In the present embodiment, after the obtaining unit 2701 of the first computing device receives the target first data submatrix and the target second data submatrix, the first processing unit 2702 initiates the matrix multiplication operation process to process the received target first data submatrix and the target second data submatrix, and in parallel with the processing, copy the first candidate data submatrix in the other N-1 computing devices.

The first processing unit 2702 can initiate the matrix multiplication operation process by calling a General Matrix Multiply (GEMM) kernel.

After the first processing unit 2702 completes the initiation of the matrix multiplication operation process, the first processing unit 2702 can copy the first candidate data submatrix in the other N-1 computing devices in parallel with the matrix multiplication operation processing on the target first data submatrix and target second data submatrix.

In other words, the first processing unit 2702 communicates with the other N-1 computing devices in parallel with the processing of the matrix multiplication operation on the existing data submatrices, thereby copying the first candidate data submatrix in the other N-1 computing devices, which can achieve an overlap between computing and communication during the parallel processing by the computing devices such as a GPU, an NPU, a GPU-like device, or an XPU.

When the first processing unit 2702 processes the received target first data submatrix and the target second data submatrix, the implementation method that can be applied is: dividing the target first data submatrix into a plurality of target first matrix blocks and dividing the target second data submatrix into a plurality of target second matrix blocks according to a first preset block size; obtaining a processing result between the target first data submatrix and the target second data submatrix based on the plurality of target first matrix blocks and the plurality of target second matrix blocks, and the obtained processing result is the result of the matrix multiplication.

In the present embodiment, the first preset block size can be a block size that matches the size of a Warp (a Warp is a basic unit for scheduling and execution in a GPU).

In other words, the first processing unit 2702 achieves the purpose of performing Warp-level computing within the called GEMM kernel by dividing the data submatrices and then performing matrix multiplication operation between the data submatrices according to the matrix blocks obtained by the dividing, which can improve the computing efficiency of the first computing device such as a GPU, an NPU, a GPU-like device, or an XPU when performing matrix multiplication.

In the present embodiment, the first candidate data submatrix to be copied by the first processing unit 2702 from the other N-1 computing devices can be all or some of the first data submatrices corresponding to the other N-1 computing devices, or can be all or some of the second data submatrices corresponding to the other N-1 computing devices.

In the present embodiment, when the first processing unit 2702 copies the first candidate data submatrix in the other N-1 computing devices, the implementation method that can be applied is: constructing a partitioning method set based on the first partitioning method, the second partitioning method, and a third partitioning method corresponding to the output data matrix; determining the first candidate data submatrix based on the constructed partitioning method set; copying the first candidate data submatrix in the other N-1 computing devices.

The first processing unit 2702 achieves the purpose of copying the first candidate data submatrix from the other N-1 computing devices by accessing the memory of the other N-1 computing devices.

In the present embodiment, the output data matrix is the target processing result between the first data matrix and the second data matrix. The third partitioning method can be row partitioning (i.e. partitioning the output data matrix in the row direction) or column partitioning (i.e. partitioning the output data matrix in the column direction).

In the present embodiment, different partitioning method sets correspond to different types of the first candidate data submatrix. Thus the first computing device determines what type of the first candidate data submatrix to copy from the other N-1 computing devices based on the constructed partitioning method set.

In the present embodiment, the first processing unit 2702 obtains the first candidate data submatrix required for matrix multiplication operation from the other N-1 computing devices by copying, thereby avoiding the steps of sending and receiving submatrices between computing devices. This can reduce the time required for the computing device, such as a GPU, an NPU, a GPU-like device, or an XPU, to obtain the first candidate data submatrix in the other N-1 computing devices, thereby improving the efficiency of subsequent matrix multiplication operation based on the first candidate data submatrix.

The first processing unit 2702 can store the copied first candidate data submatrix corresponding to different other computing devices into the memory of the first computing device, so as to obtain the first candidate data submatrix during subsequent processing.

The first processing unit 2702, when executing S102 to copy first candidate data submatrix from the other N-1 computing devices, can copy the first candidate data submatrix in the other N-1 computing devices multiple times according to a second preset block size, that is, copy matrix blocks corresponding to the second preset block size from the other N-1 computing devices each time. The second preset block size in the present embodiment can be the same as or different from the first preset block size. The second preset block size in the present embodiment can be set according to actual requirements.

In other words, the first processing unit 2702 can copy the first candidate data submatrix in the other N-1 computing devices multiple times according to smaller blocks. Thus, after completing the processing between the target first data submatrix and the target second data submatrix, the first computing device can perform matrix multiplication operation more quickly using the already copied first candidate data submatrix (or the matrix blocks corresponding to the first candidate data submatrix), which can further improve the overlap efficiency between computing and communication for the computing device, such as a GPU, an NPU, a GPU-like device, or an XPU.

When the first processing unit 2702 executes “copy first candidate data submatrices in the other N-1 computing devices”, the implementation method that can be applied in the present embodiment can include: obtaining a preset cyclic order among the N computing devices; copying the first candidate data submatrix in the computing devices located after the first computing device in sequence according to the preset cyclic order.

In other words, the first processing unit 2702 copies the first candidate data submatrix in the computing devices located after it in sequence according to the preset cyclic order among N computing devices, ensuring orderly progress of the data copying process.

The first processing unit 2702 copies the first candidate data submatrix from the computing devices located after it in sequence, so that after completing the copy of the candidate data submatrix from the current computing device, the candidate data submatrix in the computing device next to the current computing device is copied, and the process continues.

In the first computing device of the present embodiment, after the first processing unit 2702 completes its execution, the second processing unit 2703 processes the copied first candidate data submatrix and the target data submatrix corresponding to the first candidate data submatrix, in response to obtaining the first processing result between the target first data submatrix and the target second data submatrix.

In the present embodiment, if the first candidate data submatrix is the first data submatrix in the other N-1 computing devices, then the target data submatrix corresponding to the first candidate data submatrix is the target second data submatrix in the first computing device. If the first candidate data submatrix is the second data submatrix in the other N-1 computing devices, then the target data submatrix corresponding to the first candidate data submatrix is the target first data submatrix in the first computing device.

After the second processing unit 2703 determines that the matrix multiplication operation between the target first data submatrix and target second data submatrix is completed, it can immediately perform matrix multiplication operation between the first candidate data submatrix which is copied from the other N-1 computing devices and the target data submatrix corresponding to the first candidate data submatrix.

It can be understood that the second processing unit 2703 is also configured to: obtain a status of copying the first candidate data submatrix; in response to determining that the status is that the copying is not completed, continue to copy the remaining first candidate data submatrix in the other N-1 computing devices, in parallel with processing the copied first candidate data submatrix and the target data submatrix corresponding to the first candidate data submatrix.

In the first computing device of the present embodiment, after the second processing unit 2703 completes its execution, the third processing unit 2704 obtains the target processing result of the first computing device based on the first processing result and the candidate processing result, in response to obtaining the second processing result between the first candidate data submatrix and the target data submatrix corresponding to the first candidate data submatrix.

In the present embodiment, the target processing result of the first computing device is concatenated with the N-1 target processing results of the other N-1 computing devices to obtain the output data matrix, which is the target processing result between the first data matrix and the second data matrix.

The second processing result obtained by the third processing unit 2704 is the complete processing result between the first candidate data submatrices and their corresponding target data submatrices.

The second processing result obtained by the third processing unit 2704 is the complete processing result between the first candidate data submatrix and the target data submatrix corresponding to the first candidate data submatrix.

After the third processing unit 2704 obtains the second processing result between the first candidate data submatrix and the target data submatrix corresponding to the first candidate data submatrix, it can close the matrix multiplication operation process, and then obtain the target processing result corresponding to the first computing device based on the first processing result and the second processing result.

In some special cases, such as when the first candidate data submatrix copied by the first computing device is the first data submatrix in the other N-1 computing devices, the third processing unit 2704 also obtains the target processing result corresponding to the first computing device based on the first computing result and the second computing result copied from the other N-1 computing devices.

In other words, the third processing unit 2704 can obtain the target processing result either based on the first computing result and second computing result computed by itself, or based on the first computing result computed by itself and the second computing result computed by other computing devices, which can further improve the accuracy of the obtained target processing result.

When the third processing unit 2704 executes “obtaining a target processing result of the first computing device based on the first processing result and the second processing result”, the implementation method that can be applied in the present embodiment can include: constructing a partitioning method set based on the first partitioning method, the second partitioning method, and a third partitioning method corresponding to the output data matrix; determining a second candidate data submatrix based on the partitioning method set; copying the second candidate data submatrix in the other N-1 computing devices; obtaining the target processing result of the first computing device based on the first processing result, the second processing result, and the second candidate data submatrix.

In other words, the third processing unit 2704 can also determine the second candidate data submatrices to be copied from the other N-1 computing devices based on the constructed partitioning method set, and then obtain the corresponding target processing result based on the first processing result and the second processing result which are obtained by its own, and the copied second candidate data submatrices.

In the present embodiment, different partitioning method sets correspond to different second candidate data submatrices. The second candidate data submatrices are the second computing results obtained through matrix multiplication operation by the other N-1 computing devices.

In the technical solution of this disclosure, the acquisition, storage, and application of user personal information comply with relevant laws and regulations and do not violate public order and good morals.

According to the embodiment of the present disclosure, there are also provided an electronic device, a readable storage medium and a computer program product.

FIG. 28 is a block diagram of an electronic device for the method for parallel processing of model according to the embodiment of the present disclosure. The electronic device is intended to represent various forms of digital computers, such as laptop computers, desktop computers, workstations, personal digital assistants, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 28, the device 2800 includes a computing unit 2801 which may perform various appropriate actions and processing operations according to a computer program stored in a read only memory (ROM) 2802 or a computer program loaded from a storage unit 2808 into a random access memory (RAM) 2803. Various programs and data necessary for the operation of the device 2800 may be also stored in the RAM 2803. The computing unit 2801, the ROM 2802, and the RAM 2803 are connected with one other through a bus 2804. An input/output (I/O) interface 2805 is also connected to the bus 2804.

The plural components in the device 2800 are connected to the I/O interface 2805, and include: an input unit 2806, such as a keyboard, a mouse, or the like; an output unit 2807, such as various types of displays, speakers, or the like; the storage unit 2808, such as a magnetic disk, an optical disk, or the like; and a communication unit 2809, such as a network card, a modem, a wireless communication transceiver, or the like. The communication unit 2809 allows the device 2800 to exchange information/data with other devices through a computer network, such as the Internet, and/or various telecommunication networks.

The computing unit 2801 may be a variety of general and/or special purpose processing components with processing and computing capabilities. Some examples of the computing unit 2801 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 2801 performs the methods and processing operations described above, such as the method for training a question solving model or the question solving method. For example, in some embodiments, the method for training a question solving model or the question solving method may be implemented as a computer software program tangibly included in a machine readable medium, such as the storage unit 2808.

In some embodiments, part or all of the computer program may be loaded and/or installed into the device 2800 via the ROM 2802 and/or the communication unit 2809. When the computer program is loaded into the RAM 2803 and executed by the computing unit 2801, one or more steps of the method for training a question solving model or the question solving method described above may be performed. Alternatively, in other embodiments, the computing unit 2801 may be configured to perform the method for training a question solving model or the question solving method by any other suitable means (for example, by means of firmware).

Various implementations of the systems and technologies described herein may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided for a processor or a controller of a general purpose computer, a special purpose computer, or training apparatuses of other programmable vehicle positioning or positioning models, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may include or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server, also called a cloud computing server or a cloud host, and is a host product in a cloud computing service system, so as to overcome the defects of high management difficulty and weak service expansibility in conventional physical host and virtual private server (VPS) service. The server may also be a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A method for parallel processing of model, which is applied to a first computing device among N computing devices, the method comprising:
obtaining a target first data submatrix in N first data submatrices and a target second data submatrix in N second data submatrices; wherein the N first data submatrices are obtained by partitioning a first data matrix according to a first partitioning method, and the N second data submatrices are obtained by partitioning a second data matrix according to a second partitioning method; N is a positive integer greater than or equal to 2;
initiating a matrix multiplication operation process to process the target first data submatrix and the target second data submatrix, and in parallel with the processing, copy a first candidate data submatrix in the other N-1 computing devices;
in response to obtaining a first processing result between the target first data submatrix and the target second data submatrix, processing the copied first candidate data submatrix and a target data submatrix corresponding to the first candidate data submatrix;
in response to obtaining a second processing result between the first candidate data submatrix and the target data submatrix corresponding to the first candidate data submatrix, obtaining a target processing result of the first computing device based on the first processing result and the second processing result; wherein the target processing result of the first computing device is used to be concatenated with N-1 target processing results of the other N-1 computing devices to obtain a target processing result between the first data matrix and the second data matrix.

2. The method according to claim 1, wherein the processing the target first data submatrix and the target second data submatrix comprises:
dividing the target first data submatrix into a plurality of target first matrix blocks and dividing the target second data submatrix into a plurality of target second matrix blocks according to a first preset block size;
obtaining a processing result between the target first data submatrix and the target second data submatrix based on the plurality of target first matrix blocks and the plurality of target second matrix blocks.

3. The method according to claim 1, wherein the copying the first candidate data submatrix in the other N-1 computing devices comprises:
constructing a partitioning method set based on the first partitioning method, the second partitioning method, and a third partitioning method corresponding to the output data matrix;
determining the first candidate data submatrix based on the constructed partitioning method set;
copying the first candidate data submatrix in the other N-1 computing devices.

4. The method according to claim 3, wherein the copying the first candidate data submatrix in the other N-1 computing devices comprises:
copying the first candidate data submatrix in the other N-1 computing devices multiple times according to a second preset block size.

5. The method according to claim 4, wherein the processing the copied first candidate data submatrix and a target data submatrix corresponding to the first candidate data submatrix comprises:
obtaining a status of copying the first candidate data submatrix;
in response to determining that the status is that the copying is not completed, continuing to copy the remaining first candidate data submatrix in the other N-1 computing devices, in parallel with processing the copied first candidate data submatrix and the target data submatrix corresponding to the first candidate data submatrix.

6. The method according to claim 1, wherein the obtaining the target processing result of the first computing device based on the first processing result and the second processing result comprises:
constructing a partitioning method set based on the first partitioning method, the second partitioning method, and a third partitioning method corresponding to the output data matrix;
determining a second candidate data submatrix based on the partitioning method set;
copying the second candidate data submatrix in the other N-1 computing devices;
obtaining the target processing result of the first computing device based on the first processing result, the second processing result, and the second candidate data submatrix.

7. The method according to claim 1, wherein the copying first candidate data submatrices in the other N-1 computing devices comprises:
obtaining a preset cyclic order among the N computing devices;
copying the first candidate data submatrix in the computing devices located after the first computing device in sequence according to the preset cyclic order.

8. An electronic device, comprising:
at least one processor; and
a memory communicatively connected with the at least one processor;
wherein the memory stores instructions executable by the at least one processor, and the instructions are executed by the at least one processor to enable the at least one processor to perform a method for training a question solving model, wherein the method for training a question solving model comprises:
obtaining a target first data submatrix in N first data submatrices and a target second data submatrix in N second data submatrices; wherein the N first data submatrices are obtained by partitioning a first data matrix according to a first partitioning method, and the N second data submatrices are obtained by partitioning a second data matrix according to a second partitioning method; N is a positive integer greater than or equal to 2;
initiating a matrix multiplication operation process to process the target first data submatrix and the target second data submatrix, and in parallel with the processing, copy a first candidate data submatrix in the other N-1 computing devices;
in response to obtaining a first processing result between the target first data submatrix and the target second data submatrix, processing the copied first candidate data submatrix and a target data submatrix corresponding to the first candidate data submatrix;
in response to obtaining a second processing result between the first candidate data submatrix and the target data submatrix corresponding to the first candidate data submatrix, obtaining a target processing result of the first computing device based on the first processing result and the second processing result; wherein the target processing result of the first computing device is used to be concatenated with N-1 target processing results of the other N-1 computing devices to obtain a target processing result between the first data matrix and the second data matrix.

9. The electronic device according to claim 8, wherein the processing the target first data submatrix and the target second data submatrix comprises:
dividing the target first data submatrix into a plurality of target first matrix blocks and dividing the target second data submatrix into a plurality of target second matrix blocks according to a first preset block size;
obtaining a processing result between the target first data submatrix and the target second data submatrix based on the plurality of target first matrix blocks and the plurality of target second matrix blocks.

10. The electronic device according to claim 8, wherein the copying the first candidate data submatrix in the other N-1 computing devices comprises:
constructing a partitioning method set based on the first partitioning method, the second partitioning method, and a third partitioning method corresponding to the output data matrix;
determining the first candidate data submatrix based on the constructed partitioning method set;
copying the first candidate data submatrix in the other N-1 computing devices.

11. The electronic device according to claim 10, wherein the copying the first candidate data submatrix in the other N-1 computing devices comprises:
copying the first candidate data submatrix in the other N-1 computing devices multiple times according to a second preset block size.

12. The electronic device according to claim 11, wherein the processing the copied first candidate data submatrix and a target data submatrix corresponding to the first candidate data submatrix comprises:
obtaining a status of copying the first candidate data submatrix;
in response to determining that the status is that the copying is not completed, continuing to copy the remaining first candidate data submatrix in the other N-1 computing devices, in parallel with processing the copied first candidate data submatrix and the target data submatrix corresponding to the first candidate data submatrix.

13. The electronic device according to claim 8, wherein the obtaining the target processing result of the first computing device based on the first processing result and the second processing result comprises:
constructing a partitioning method set based on the first partitioning method, the second partitioning method, and a third partitioning method corresponding to the output data matrix;
determining a second candidate data submatrix based on the partitioning method set;
copying the second candidate data submatrix in the other N-1 computing devices;
obtaining the target processing result of the first computing device based on the first processing result, the second processing result, and the second candidate data submatrix.

14. The electronic device according to claim 8, wherein the copying first candidate data submatrices in the other N-1 computing devices comprises:
obtaining a preset cyclic order among the N computing devices;
copying the first candidate data submatrix in the computing devices located after the first computing device in sequence according to the preset cyclic order.

15. A non-transitory computer readable storage medium with computer instructions stored thereon, wherein the computer instructions are used for causing a method for parallel processing of model, wherein the method for parallel processing of model comprises:
obtaining a target first data submatrix in N first data submatrices and a target second data submatrix in N second data submatrices; wherein the N first data submatrices are obtained by partitioning a first data matrix according to a first partitioning method, and the N second data submatrices are obtained by partitioning a second data matrix according to a second partitioning method; N is a positive integer greater than or equal to 2;
initiating a matrix multiplication operation process to process the target first data submatrix and the target second data submatrix, and in parallel with the processing, copy a first candidate data submatrix in the other N-1 computing devices;
in response to obtaining a first processing result between the target first data submatrix and the target second data submatrix, processing the copied first candidate data submatrix and a target data submatrix corresponding to the first candidate data submatrix;
in response to obtaining a second processing result between the first candidate data submatrix and the target data submatrix corresponding to the first candidate data submatrix, obtaining a target processing result of the first computing device based on the first processing result and the second processing result; wherein the target processing result of the first computing device is used to be concatenated with N-1 target processing results of the other N-1 computing devices to obtain a target processing result between the first data matrix and the second data matrix.

16. The non-transitory computer readable storage medium according to claim 15, wherein the processing the target first data submatrix and the target second data submatrix comprises:
dividing the target first data submatrix into a plurality of target first matrix blocks and dividing the target second data submatrix into a plurality of target second matrix blocks according to a first preset block size;
obtaining a processing result between the target first data submatrix and the target second data submatrix based on the plurality of target first matrix blocks and the plurality of target second matrix blocks.

17. The non-transitory computer readable storage medium according to claim 15, wherein the copying the first candidate data submatrix in the other N-1 computing devices comprises:
constructing a partitioning method set based on the first partitioning method, the second partitioning method, and a third partitioning method corresponding to the output data matrix;
determining the first candidate data submatrix based on the constructed partitioning method set;
copying the first candidate data submatrix in the other N-1 computing devices.

18. The non-transitory computer readable storage medium according to claim 17, wherein the copying the first candidate data submatrix in the other N-1 computing devices comprises:
copying the first candidate data submatrix in the other N-1 computing devices multiple times according to a second preset block size.

19. The non-transitory computer readable storage medium according to claim 18, wherein the processing the copied first candidate data submatrix and a target data submatrix corresponding to the first candidate data submatrix comprises:
obtaining a status of copying the first candidate data submatrix;
in response to determining that the status is that the copying is not completed, continuing to copy the remaining first candidate data submatrix in the other N-1 computing devices, in parallel with processing the copied first candidate data submatrix and the target data submatrix corresponding to the first candidate data submatrix.

20. The non-transitory computer readable storage medium according to claim 15, wherein the obtaining the target processing result of the first computing device based on the first processing result and the second processing result comprises:
constructing a partitioning method set based on the first partitioning method, the second partitioning method, and a third partitioning method corresponding to the output data matrix;
determining a second candidate data submatrix based on the partitioning method set;
copying the second candidate data submatrix in the other N-1 computing devices;
obtaining the target processing result of the first computing device based on the first processing result, the second processing result, and the second candidate data submatrix.
